(19) United States
(12) Patent Application Publication
(10) Pub. No.: US 2006/0156041 A1
(43) Pub. Date: Jul. 13, 2006

(54) System and method for power management of plural information handling systems

(76) Inventors: Lee Zaretsky, Austin, TX (US); Mukund P. Khatri, Austin, TX (US)

Correspondence Address: HAMILTON & TERRILE, LLP, P.O. BOX 203518, AUSTIN, TX, 78720, US

(21) Appl. No.: 11/031,804

(22) Filed: Jan. 7, 2005

(51) Int. Cl. G06F 1/30

(52) U.S. Cl. 713/300

(57) ABSTRACT

Information handling system power consumption across plural information handling systems, such as a rack of servers, is managed to restrict operations of the information handling systems to within a maximum total power consumption. Power consumption is restricted if necessary to maintain a level below the maximum by selectively operating one or more information handling systems in a reduced power mode or by disapproving operation of one or more information handling systems. Monitoring of power consumption and configuration of reduced power consumption modes is managed by a management controller associated with each information handling system.

### BACKGROUND OF THE INVENTION

1. Field of the Invention

The present invention relates in general to the field of information handling system power management, and more particularly to a system and method for power management of plural information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have improved considerably in their performance capabilities over the past several years and are likely to continue to improve over the foreseeable future. For instance, processing element designs have gained in processing speeds through advances in technology that have packed high levels of performance with greater densities. One difficulty that has arisen with this improved performance is that information handling systems tend to consume greater amounts of power and to generate greater amounts of excess heat. The cumulative impact of increased power usage by processing components may be substantial where large numbers of information handling systems operate, such as in data centers. In addition to the consumption of power by the information handling systems themselves, the overall power use may be further increased by environmental factors, such as increased power consumption associated with cooling and decreased power availability for information handling systems due to periodic power supply variances. Data centers or other organizations that run multiple information handling systems often expend considerable resources in an attempt to maintain a steady power supply for use by the information handling systems.

One difficulty faced by information technology professionals is ensuring an adequate power supply for multiple information handling systems where the power consumed changes as information handling systems are added or replaced. This task is made more complex where the available power fluctuates, whether due to fluctuations from the source of power or fluctuations in the use of available power by other resources, such as cooling resources. Information handling systems do often include various ways of managing power, but power management typically relates to reducing power consumption while operating on internal battery power so that the battery does not discharge too rapidly. For instance, processors, hard disc drives, displays and cooling fans often include reduced power consumption modes that trade off suboptimal performance for reduced power consumptions. Such power management systems typically relate to the operation of a single information handling system on an internal power source and are disabled when that information handling system operates with external power.

### SUMMARY OF THE INVENTION

Therefore a need has arisen for a system and method which provides power management for plural information handling systems.

In accordance with the present invention, a system and method are provided which substantially reduce the disadvantages and problems associated with previous methods and systems for managing power consumption by information handling systems. Power consumption across plural information handling systems is compared with available power resources to select unrestricted operation of one or more systems or restricted operations of one or more systems that will maintain power consumption of the plural information handling systems within available power resource constraints.

More specifically, a local management controller is associated with each information handling system server of a rack of servers, with one local management controller designated as a common management controller. The common management controller maintains a power resources table listing available power resources and a power consumption table listing power consumption by the information handling system servers. The common management controller monitors power consumption by the information handling system servers and enforces restricted operations of one or more information handling system servers if the power consumption exceeds the available power resources. For instance, if local management controller associated with an information handling system server requests to power-up, the common management controller denies approval to start-up if the addition of the maximum configured power of the starting server to the present total rack power of the operation servers exceeds the maximum total rack power delivered for use of all systems. The common management controller provides the maximum allowable power that the new system may consume to its local management controller and approves start-up of the new system if the local management controller can configure a reduced power consumption mode that has a maximum configured power of less than the maximum allowable power.

The present invention provides a number of important technical advantages. One example of an important technical advantage is that power consumption by plural information handling systems is automatically monitored to avoid excessive consumption. Power consumption across one or more racks of standard monolithic server information handling systems is balanced through coordinated throttling of power consumption at one or more of the systems. Given a set of constraints on power consumption, an information technology professional can configure operation of one or more racks of plural information handling systems to remain in those constraints automatically.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system server rack having power management for plural information handling system servers;

FIG. 2 depicts a flow diagram of a process for management of power consumption of plural information handling systems; and

FIG. 3 depicts a flow diagram of a process for management of power consumption at one of plural information handling systems.

### DETAILED DESCRIPTION

Power management across plural information handling systems aids operation of plural information handling systems where power constraints restrict power resources available to operate the information handling systems. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

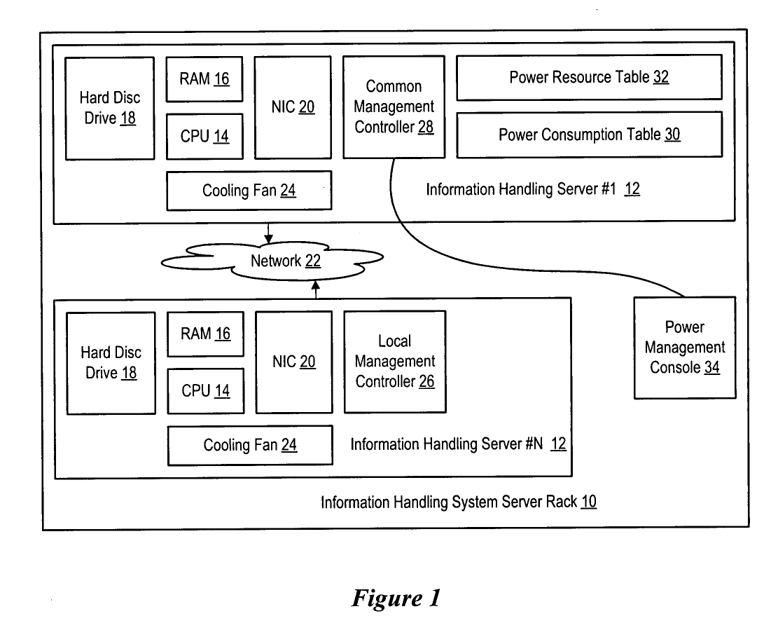

Referring now to FIG. 1, a block diagram depicts an information handling system server rack 10 having power management for plural information handling system servers 12. Information handling systems 12 include processing components for processing information, such as a CPU 14, RAM 16, a hard disc drive 18 and a NIC 20 that interfaces with one or more networks 22 or other information handling systems 12. The processing components have a variety of reduced power consumption modes that allow operation of the information handling system with less power at a generally lower performance level. For instance, CPU 14 selectively operates at a reduced clock frequency or reduced voltage to trade off the speed at which information is processed for a reduction in power consumption by the CPU, RAM 16 selectively operates at reduced clock speeds to trade off the speed at which information is stored or retrieved for a reduction in power consumption by RAM, and hard disc drive 18 selectively rotates at reduced speeds to trade off the speed at which information is stored or retrieved for a reduction in power consumption by the hard disc drive. Similarly, other components of an information handling system 12 may operate in reduced power consumption modes, such as the cooling fan 24, where the operation at the reduce power consumption mode will not impact system integrity, such as when cooling requirements are reduced due to reduced processing speeds or voltages.

Coordination of the operation of the information handling systems 12 across the server rack 10 is managed through a local management controller 26 associated with each information handling system 12. One of the local management controllers 26 is designated as the common management controller 28 that supervises each local management controller 26 across the rack 10. Local management controllers 26 interface with common management controller 28 through network 22 or through direct cables configured in an “in-out” daisy chain between the information handling systems 12. Each local management controller 26 has power consumption information for its associated information handling system 12, such as the maximum power consumed, a list of power consuming components on the associated information handling system 12, or the results of active monitoring of power consumed at the associated information handling system 12. Each local management controller 26 provides the power consumption information to common management controller 28, such as upon each boot of an information handling system 12. Common management controller 28 tracks the power consumption information by information handling system 12 in a power consumption table 30 and compares the power consumption with the available power listed in a power resources table 32 to determine whether to enforce power consumption restrictions on the operation of one or more of the information handling systems 12.

Common management controller 28 selectively enforces power consumption restrictions according to a variety of power consumption constraints. For instance, power management controller 28 monitors information handling systems 12 at initial power-up or a power reset and prohibits the local management controller 26 from powering up its associated system if available power resources are insufficient to support operation of the information handling system. Alternatively, common management controller 28 allows the local management controller 26 to start up in a reduced power consumption mode, such as with a reduced processor or memory speed, if power is sufficient to support operation of its associated information handling in the reduced power consumption mode. A power management console 34 allows selective configuration by a user of information handling system power consumption modes through common management controller 28. For instance, a user may prioritize one information handling system 12 over another so that common power management controller 28 reduces power consumption at systems having a lower priority to allow systems having a higher priority to operate, or may prioritize specific components of selected information handling systems, such as specific CPUs to operate a reduced clock speeds in the face of power resource constraints. As another example, a user may configure power resource table 32 to have varying power resources based on a time of operation so that common management controller 28 may selectively reduce power consumption over the course of time to keep overall power consumption within a desired constraint. As yet another example, power management console 34 may balance power consumption across plural server racks 10 in order to adjust power consumption constraints and availability.

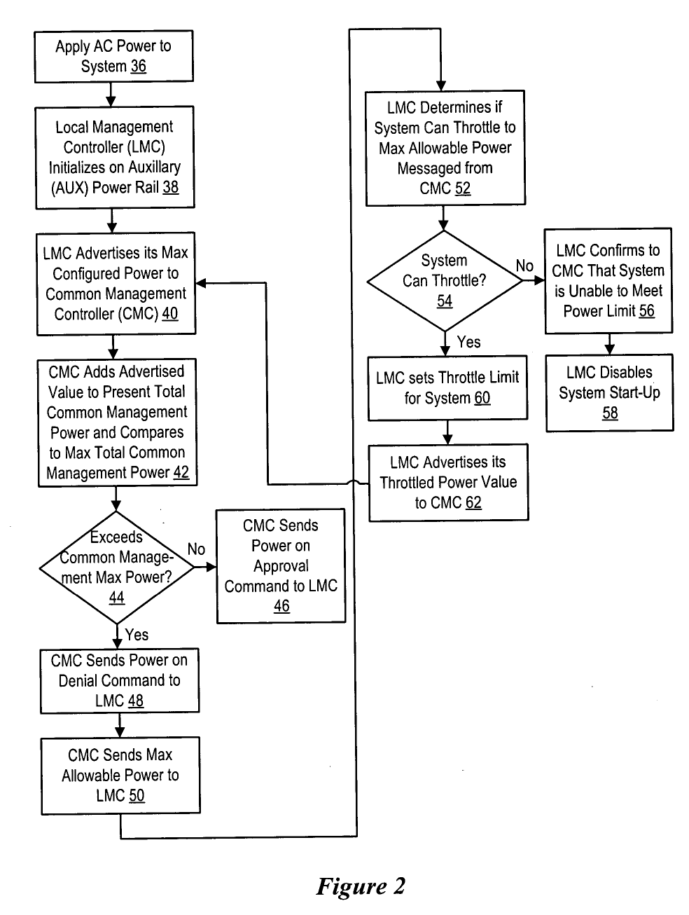

Referring now to FIG. 2, a flow diagram depicts a process for management of power consumption of plural information handling systems. The process begins at step 36 with application of power to an information handling system located on a server rack. At step 38, the local management controller of the information handling system initializes on an auxiliary power rail and, at step 40, advertises its maximum configured power to the common management controller of the information handling system server rack. The maximum configured power is the maximum amount of power that a system expects to consume based on its current physical condition and may be stored on an information handling system, derived from actual power usage or derived by the common management controller from a list of components on the information handling system. At step 42, the common management controller adds the advertised value to the present total value of rack power, meaning the sum total of maximum configured power values for all operational systems on the rack, and compares the total value with the maximum total rack power, meaning the maximum amount of power delivered into the rack for use by all information handling systems. If at step 44 the total value of the present rack power and the advertised power do not exceed the rack maximum power, the process continues to step 46 at which the common management controller sends power-on approval for unrestricted operation to the local management controller.

If at step 44 the total value of the present rack power and the advertised power do exceed the rack maximum power, the process continues to determine whether to approve restricted operation of the information handling system. At step 48, the common management controller sends a power-on denial the local management controller and, at step 50, also sends the maximum allowable power, meaning the maximum amount of unallocated power that can be delivered to an information handling system based on the amount of power already allocated to systems on the rack, i.e., the maximum total rack power minus the present total rack power. At step 52, the local management controller determines if its associated system can operate in a throttled state within the maximum allowable power messaged from the common management controller, such as by throttling CPU or memory operations. At step 54, if a throttled state cannot be supported with the maximum allowable power, the process continues to step 56 at which the local management controller communicates the inability to operate within the power constraint to the common management controller and, at step 58, disables system start-up. If at step 54 a throttled state exists that supports operation within the maximum allowable power, the process continues to step 60 for the local management controller to configure the throttled state and to step 62 for the local management controller to advertise its throttled power value to the common management controller. From step 62, the process continues to step 42 to ensure that sufficient power is available to operate the information handling system in the throttled state.

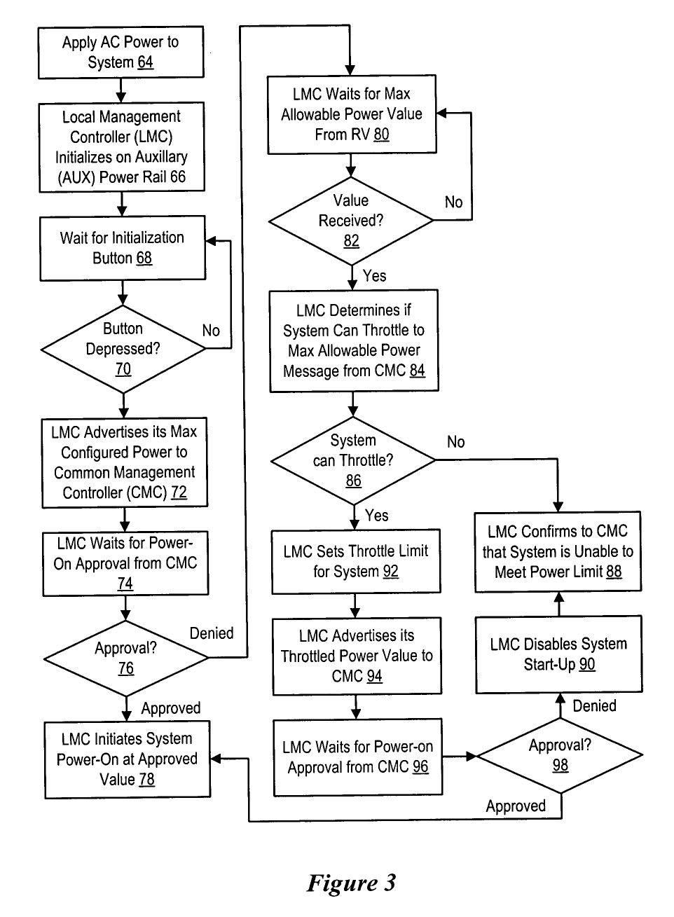

Referring now to FIG. 3, a flow diagram depicts a process for management of power consumption at one of plural information handling systems. The process begins at step 64 with application of power to the system and continues to step 66 for initialization of the local management controller on auxiliary power and selection of the initialization button at steps 68 and 70. At step 72, the local management controller advertises the maximum configured power of its associated information handling system to the common management controller and, at step 74, awaits approval from the common management controller to power up the information handling system. If approval is received at step 76, the local management controller initiates system power on in an unrestricted power consumption mode. If denial is received at step 76, the process continues to steps 80 and 82 at which the local management controller awaits the maximum allowable power from the common management controller. Once the maximum allowable power is received, at step 84 the local management controller determines if the information handling system can operate within the maximum allowable power by entering a throttled state. If at step 86 the local management controller determines that throttled state does not exist, the process continues to step 88 for the local management controller to communicate the inability to start-up to the common management controller and to step 90 for disabling of start-up of the associated information handling system. If a throttled at step 86 a throttle state does exist, the process continues to step 92 for configuration of the system to operate in the throttled state, step 94 for the local management controller to advertise the throttled power and step 96 for approval of start-up at the throttled power from the common management controller. If start-up approval is received at step 98, the process returns to step 78 to start-up. If start-up approval is denied at step 98, the process returns to step 90 for disabling of start-up.

Although the present invention has been described in detail, it should be understood that various changes, substitutions and alterations can be made hereto without departing from the spirit and scope of the invention as defined by the appended claims.

What is claimed is:

1. A system for managing power consumption across plural information handling systems, the system comprising:
a local management controller associated with each of the information handling systems, each local management controller having power consumption information for its associated information handling system and operable to selectively enforce one or more throttled power consumption modes at its associated information handling system; and
a common management controller interfaced with each local management controller, the common management controller having a power resource table of available power resources and a power consumption table of power consumption information provided from each local management controller, the common management controller operable to selectively restrict operation of one or more information handling systems to maintain power consumption of the plural information handling systems within the available power resources.

2. The system of claim 1 further comprising a power management console interfaced with the common management controller and operable to configure the common management controller to restrict operation of selected of the information handling systems.

3. The system of claim 1 wherein the common management controller selectively restricts operation of one or more information handling systems by selectively enforcing a throttled power consumption mode at one or more information handling systems.

4. The system of claim 3 wherein the throttled power consumption mode comprises manipulation of clock signals to reduce power consumption of one or more processing components.

5. The system of claim 4 wherein the processing component comprises a CPU of the information handling system.

6. The system of claim 4 wherein the processing component comprises random access memory of the information handling system.

7. The system of claim 3 wherein the throttled power consumption mode comprises manipulation of CPU voltages to reduce power consumption.

8. The system of claim 3 wherein the power resource table has time-based power constraints and the power management controller is further operable to provide time-based selective restrictions at one or more of the information handling systems to meet the time-based power constraints.

9. The system of claim 1 wherein the local management controller power consumption information comprises information derived from active monitoring of power consumption of at least one information handling system associated with a local management controller.

10. A method for managing power consumption of plural information handling systems, the method comprising:
defining a maximum total power associated with the plural information handling systems;
monitoring the total power used by the plural information handling systems;
determining that an information handling system request will exceed the maximum total power; and
restricting operation of one or more of the information handling systems to maintain the total power used by the information handling systems less than the maximum total power.

11. The method of claim 10 wherein the information handling system request comprises a request by one or the information handling systems to power up and restricting operation further comprises denying approval of the information handling system to power up.

12. The method of claim 10 wherein the information handling system request comprises a request by one of the information handling systems to power up and restricting operation further comprises approving power up of the information handling system in a reduced power consumption mode.

13. The method of claim 12 wherein approving power up of the information handling system in a reduced power consumption mode further comprises approving power up of the information handling system with a reduced clock speed to operate one or more CPUs of the information handling system.

14. The method of claim 12 wherein approving power up of the information handling system in a reduced power consumption mode further comprises approving power up of the information handling system with a reduced clock speed to operate memory of the information handling system.

15. The method of claim 12 wherein approving power up of the information handling system in a reduced power consumption mode further comprises approving power up of the information handling system with a reduced operating voltage for one or more CPUs of the information handling system.

16. The method of claim 12 wherein approving power up of the information handling system in a reduced power consumption mode further comprises approving power up of the information handling system with a reduced hard disc drive operating speed of the information handling system.

17. An information handling system comprising:
processing components operable to process information, at least some of the processing components having a reduced power consumption mode; and
a power management controller interfaced with the processing components, the power management controller having a maximum total power for use by the information handling system and plural other information handling systems, the power management controller operable to restrict operation of the processing components if power consumption associated with start-up of the processing components plus power consumption of the other information handling systems will exceed the maximum total power.

18. The information handling system of claim 17 wherein the power management controller restricts operation of the processing components by prohibiting start-up of the processing components.

19. The information handling system of claim 18 wherein the power management controller restricts operation of the processing components by starting-up one or more of the processing components in a reduced power consumption mode that avoids exceeding the maximum total power.

20. The information handling system of claim 19 wherein the processing component comprises a CPU and the reduced power consumption mode comprises a reduced clock speed.
